(19) United States
(12) Patent Application Publication
(10) Pub. No.: US 2009/0174289 A1
(43) Pub. Date: Jul. 9, 2009

(54) MAGNETIC IMPULSE ENERGY HARVESTING DEVICE AND METHOD

(75) Inventor: Edward T. Tanner, Williamsburg, VA (US)

Correspondence Address: NIXON & VANDERHYE, PC, 901 NORTH GLEBE ROAD, 11TH FLOOR, ARLINGTON, VA, 22203, US

(73) Assignee: AdaptivEnergy LLC, Hampton, VA (US)

(21) Appl. No.: 12/341,141

(22) Filed: Dec. 22, 2008

Related U.S. Application Data
(60) Provisional application No. 61/017,483, filed on Dec. 28, 2007.

(51) Int. Cl. H02N 2/18

(52) U.S. Cl. 310/339

(57) ABSTRACT

An example embodiment of an energy harvesting device (20) comprising a piezoelectric element (30) provides two degrees of vibration freedom for the piezoelectric element and magnetic soft impact, thereby enhancing power output of the piezoelectric element. The example embodiment of an energy harvesting device (20) comprises a frame (22); a body (28) configured to oscillate with respect to the frame upon vibration of the frame; a piezoelectric member (30); and, at least one frame magnet (32) mounted on the frame (22) and at least one body magnet (34) mounted on the body (28). The piezoelectric element (30) is connected to the body and configured to undergo deflection upon oscillation of the body (28), and upon the deflection to generate an electrical voltage. The frame magnet (32) and the body magnet (34) are of opposite polarity with one another and positioned to create a repulsive force between the frame (22) and the body (28).

This application claims the priority and benefit of U.S. Provisional Patent application 61/017,483, filed Dec. 28, 2008, entitled “MAGNETIC IMPULSE ENERGY HARVESTING DEVICE AND METHOD”, which is incorporated herein by reference in its entirety.

### BACKGROUND

I. Technical Field

This invention pertains to harvesting or scavenging of power by capitalizing upon movement or oscillation of a device.

II. Related Art and Other Considerations

The motion of many bodies, both animate and inanimate, results from either external forces acting upon the body or by exertion of energy by the body itself. For example, a human walking at a normal pace of three mph produces a power output of 233 Watts. It would be highly beneficial if energy expended during movement of a body, such as a human body or other moving body, could be scavenged and stored for useful purposes, such as powering electronic devices.

There has been considerable interest in the possibility of scavenging human power and either using it directly, or storing it for later use, to power electronic devices. While the interest in the feasibility of this concept was initially generated by the military to power an assortment of electronic equipment carried by a soldier in the field, recent interest in powering portable, personal electronic devices, such as cell phones and MP3 players, is beginning to see interest. See, for example, US Patent Publication 2001/0035723 wherein electroactive polymer devices are used to generate electrical energy by converting mechanical energy generated by heel strikes during walking into electrical energy.

To date, the problems with scavenging human energy have been summed up in several reports issued by the US United States Office of Naval Research (ONR) and the United States Defense Advanced Research Projects Agency (DARPA) Defense Sciences Office (DSO). Thus far, ONR and DARPA DSO have found such devices to date to have one or more of low power output, to be overly complex and/or bulky, or not to be cost effective.

It has previously been suggested that human power be scavenged through the up-and-down motion of the contents in a human-borne backpack. See, for example, U.S. Pat. No. 6,982,497, as well as the article appearing at http://news.nationalgeographic.com/news/2005/09/0908_{—}050908_backpack.html.

Piezoceramic devices have also been suggested to scavenge footfall energy, energy available from limb motion, and respiratory energy. U.S. Pat. No. 7,345,407, entitled “HUMAN POWERED PIEZOELECTRIC POWER GENERATING DEVICE”, and incorporated herein by reference, discloses an energy scavenging apparatus comprising a frame which can be human-carried or human-borne. Plural cantilevered bimorph piezoelectric members are connected to the frame to have an essentially parallel orientation. Each cantilevered bimorph piezoelectric member comprises a proximal end connected to the frame and a distal end. A mass member is connected to the distal end of the plural cantilevered bimorph piezoelectric members.

### BRIEF SUMMARY

An example embodiment of an energy harvesting device comprises a frame; a piezoelectric member connected to the frame; and a magnetic spring. The piezoelectric member is connected to the frame so as to experience two degrees of vibration freedom and upon experiencing vibration to generate an electrical voltage. The magnetic spring is attached to the frame and configured to provide magnetic soft impact of the piezoelectric member relative to the frame. The device provides two degrees of vibration freedom for the piezoelectric element thereby enhancing power output of the piezoelectric element and increasing the frequency bandwidth over which the device can harvest energy.

An example embodiment further comprises a body which is connected to the frame and configured to oscillate with respect to the frame upon vibration of the frame and thereby provide a first degree of vibration freedom. The piezoelectric member is connected to the frame through the body. The magnetic spring provides magnetic soft impact relative to the frame of the piezoelectric member as connected to the body. The body can be a cantilevered arm assembly which is configured to oscillate about a pivot axis on the frame. The cantilevered arm assembly can comprise two spaced apart arms which define a cavity therebetween. The piezoelectric member can be situated to undergo deflection in the cavity.

In another of its aspects, the technology disclosed herein concerns an example embodiment of an energy harvesting device which comprises a frame; a body configured to oscillate with respect to the frame upon vibration of the frame; a piezoelectric member; and, at least one frame magnet mounted on the frame and at least one body magnet mounted on the body. The piezoelectric element is connected to the body and configured to undergo deflection upon oscillation of the body, and upon the deflection to generate an electrical voltage. The frame magnet and the body magnet are of opposite polarity with one another and positioned to create a repulsive force between the frame and the body.

The frame further comprises a first bumper and a second bumper provided at spaced apart locations on the frame. A first bumper frame magnet is mounted to the first bumper; a second bumper frame magnet is mounted to the second bumper. The body carries both a body magnet aligned with the first bumper frame magnet and a body magnet aligned with the second bumper frame magnet.

In an example embodiment, the body is a cantilevered arm assembly which is configured to oscillate about a pivot axis on the frame. The body magnet aligned with the first bumper frame magnet is situated on a first surface at a distal end of the arm assembly; the body magnet aligned with second bumper frame magnet is situated on a second surface at a distal end of the arm assembly.

The first bumper has a first bumper surface; the second bumper has a second bumper surface. The body has a body first surface oriented toward the first bumper surface and a body second surface oriented toward the second bumper surface. The first bumper frame magnet is recessed with respect to the first bumper surface; the second bumper frame magnet is recessed with respect to the second bumper surface.

The cantilevered arm assembly comprises an arm mass at a distal end of the arm assembly. The body magnet aligned with the first bumper and the body magnet aligned with the second bumper are both mounted on the arm mass.

In an example embodiment, the cantilevered arm assembly comprises two spaced apart arms which define a cavity therebetween. The piezoelectric member is situated to undergo deflection in the cavity. In an example embodiment, the piezoelectric member is a cantilevered piezoelectric member which is clamped to the arm assembly proximate the pivot axis. The piezoelectric member comprises a mass-enhanced distal end.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is an exterior isometric view of an example embodiment of a piezoelectric energy harvesting device.

FIG. 2 is a top view of the energy harvesting device of FIG. 1 and further showing selected internal components by phantom lines.

FIG. 3 is a front sectional view of the energy harvesting device of FIG. 1 taken along line A-A of FIG. 2.

FIG. 4 is a side isometric sectioned view of the piezoelectric energy harvesting of FIG. 1.

FIG. 5 is a bottom isometric view of an arm assembly of an example embodiment of a piezoelectric energy harvesting device.

FIG. 6 is a top view of the arm assembly of FIG. 5.

FIG. 7 is a bottom view of the arm assembly of FIG. 5.

FIG. 8 is a top isometric view of the arm assembly of FIG. 5.

FIG. 9 is a side isometric sectioned view of the arm assembly of FIG. 5

FIG. 10 is a plan view of an example substrate of a piezoelectric element suitable for use with an energy harvesting device of FIG. 5.

FIG. 11 is a graph showing Power Output of a magnetic Impact piezoelectric energy harvesting device such as that of FIG. 1 against an identical beam device which does not have magnetic Impact.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

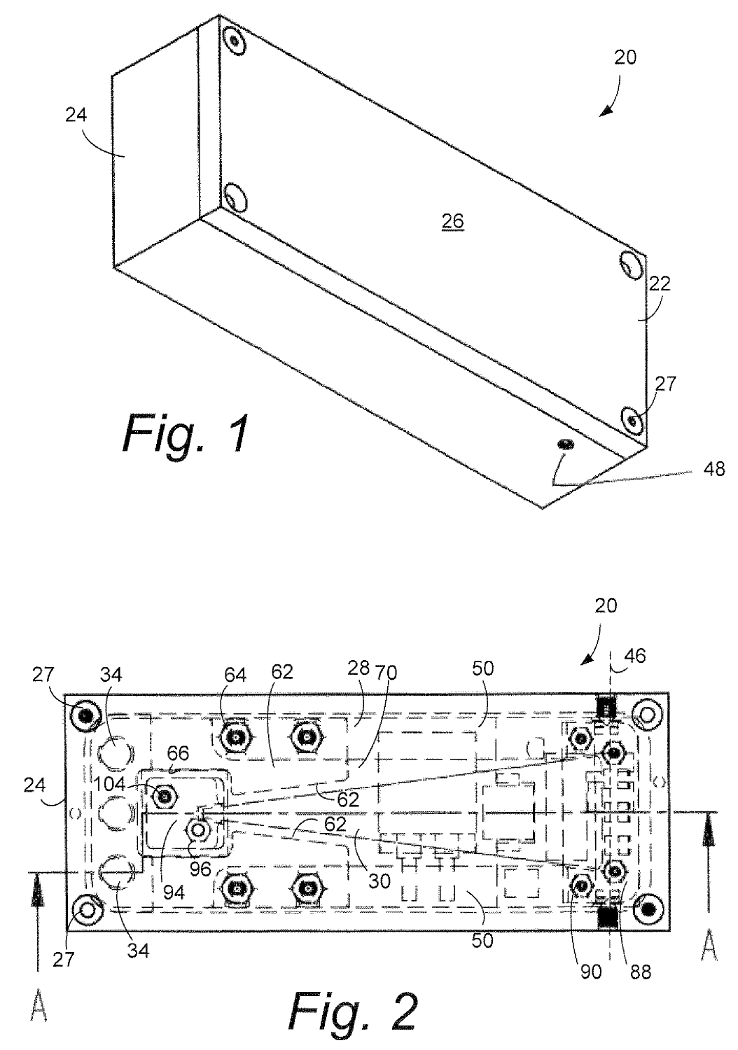

FIG. 1 shows an exterior isometric view of an example embodiment of an energy harvesting device 20, and particularly housing or frame 22 of energy harvesting device 20. As shown in FIG. 1, frame 22 has an essentially rectangular shape and to that end comprises both housing enclosure 24 and lid 26. Lid 26 can be secured to housing enclosure 24 using appropriate fasteners (such as screws 27) or by adhesive or other closing means. The shape, size, and configuration of frame 22 are not limiting features of energy harvesting device 20, as it will be understood that energy harvesting device 20 can be fashioned otherwise. The particular structure of frame 22 can depend on its implementation or mode of application. For example, the frame 22 of energy harvesting device 20 can be configured, shaped, and/or sized in accordance with a host body to which energy harvesting device 20 is mounted, fastened, attached, carried, or borne.

The host body is thus preferably of a type that undergoes movement, oscillation, or vibration, and preferably frequently or periodically, so that energy harvesting device 20 can capitalize upon such motion, etc., and indeed so that energy harvesting device 20 can utilize the motion for generating an electric voltage, e.g., for energy harvesting. The host body can be animate or inanimate. For example, the host body can be a human, and the energy harvesting device 20 can be a device that is carried directly by a human or in another object (e.g., backpack or bag) that is carried by a human.

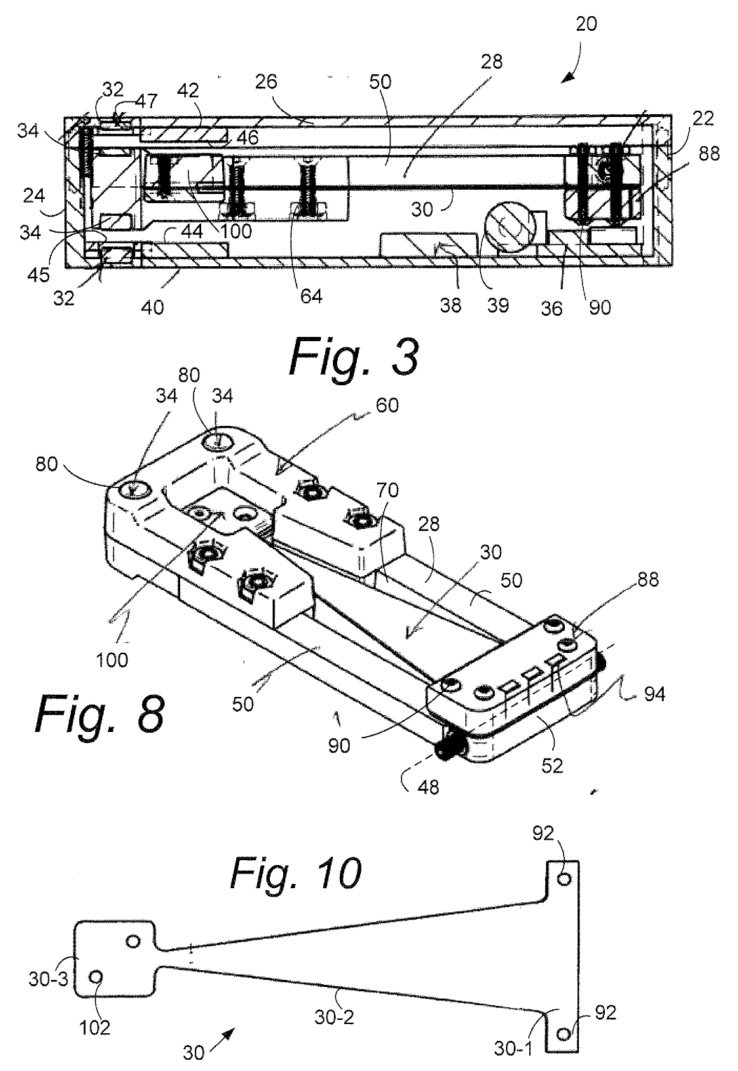

FIG. 2 shows energy harvesting device 20 from above, with its internal components illustrated in broken (phantom lines). FIG. 3 provides a sectioned view of the energy harvesting device 20 of FIG. 2 taken along line A-A of FIG. 2. FIG. 4 shows a similarly sectioned isometric view of energy harvesting device 20. From one or more of FIG. 2, FIG. 3, and FIG. 4 it can be seen that energy harvesting device 20 comprises, in addition to frame 22, body 28 configured to oscillate with respect to the frame 22 upon vibration of frame 22; piezoelectric element 30; at least one frame magnet 32 mounted on frame 22; and at least one body magnet 34 mounted on or to body 28. The frame magnet 32 and the body magnet 34 are of opposite polarity with one another and are positioned to create a repulsive force between frame 22 and body 28.

Piezoelectric element 30 is connected to body 28 and is configured to undergo deflection upon oscillation of body 28, and upon the deflection to generate an electrical voltage. Unillustrated electrical leads or wires connect from piezoelectric element 30 to circuit board 36 mounted to a floor of housing enclosure 24. The floor of housing enclosure 24 also has battery 38 mounted thereon (see FIG. 3 and FIG. 4). Inductor 39 is soldered to circuit board 36, but appears separate in FIG. 3 and FIG. 4 because it is recessed into a cutout in the circuit board to minimize the height of the assembly.

Frame 22 also comprises first bumper 40 and second bumper 42 provided at spaced apart locations on frame 22. As shown in FIG. 3 and FIG. 4, first bumper 40 is mounted on the floor of housing enclosure 24; second bumper 42 is mounted to an underside of lid 26 of frame 22. The first bumper 40 and second bumper 42 are mounted in vertical alignment with respect to their internal placement in frame 22.

At least one bumper frame magnet 32 is mounted to first bumper 40, and is thereby known as a first bumper frame magnet. Similarly, at least one bumper frame magnet 32 is mounted to second bumper 42, and is thereby known as a second bumper frame magnet. In the illustrated example embodiment shown in FIG. 3 and FIG. 4, first bumper 40 carries two bumper frame magnets 32 which are horizontally spaced apart with regard to a width of frame 22. Similarly, second bumper 42 carries two bumper frame magnets 32 which are also horizontally spaced apart with regard to the width of frame 22. Thus, there are preferably four frame magnets 32: two frame magnets 32 on the first bumper 40 and two frame magnets 32 on second bumper 42. The two frame magnets 32 which are carried on first bumper 40 are known as first bumper frame magnets. The two frame magnets 32 which are carried on second bumper 42 are known as second bumper frame magnets.

Each of the aforementioned frame magnets 32 are situated in recessed manner within their respective bumpers. In this regard, first bumper 40 has a first bumper surface 44 which is an upper surface of first bumper 40. The first bumper surface 44 has two spaced apart cavities or recesses 45 formed therein. In the particular illustrated example embodiment shown in FIG. 3 and FIG. 4, first bumper 40 carries the lower two bumper frame magnets 32 in the respective two recesses 45. Similarly, second bumper 42 has a second bumper surface 46 which is an underside surface of second bumper 42. The second bumper surface 46 has two spaced apart cavities or recesses 47 formed therein. The second bumper 42 carries the upper two bumper frame magnets 32 in the respective two recesses 47.

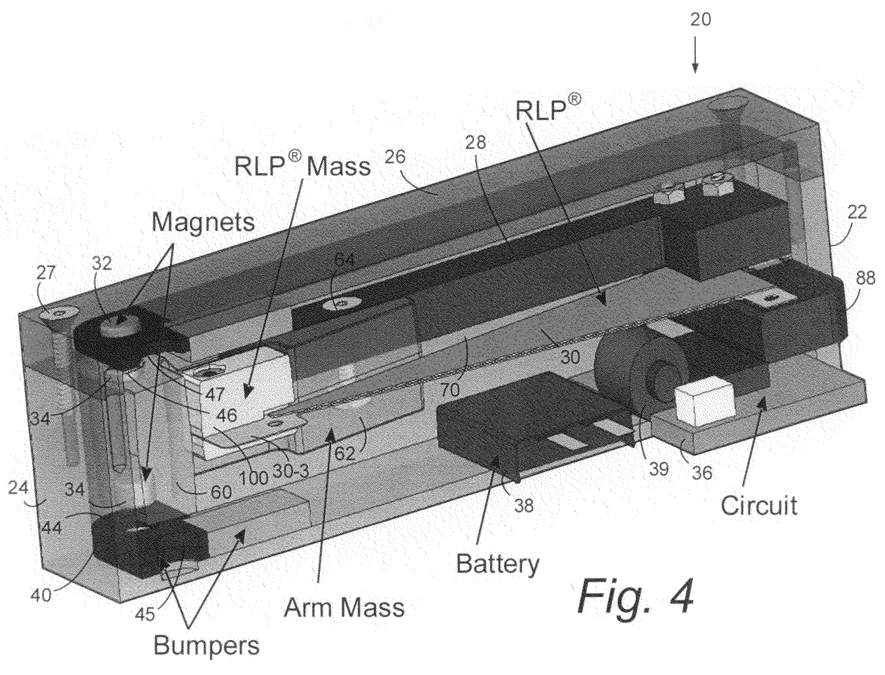

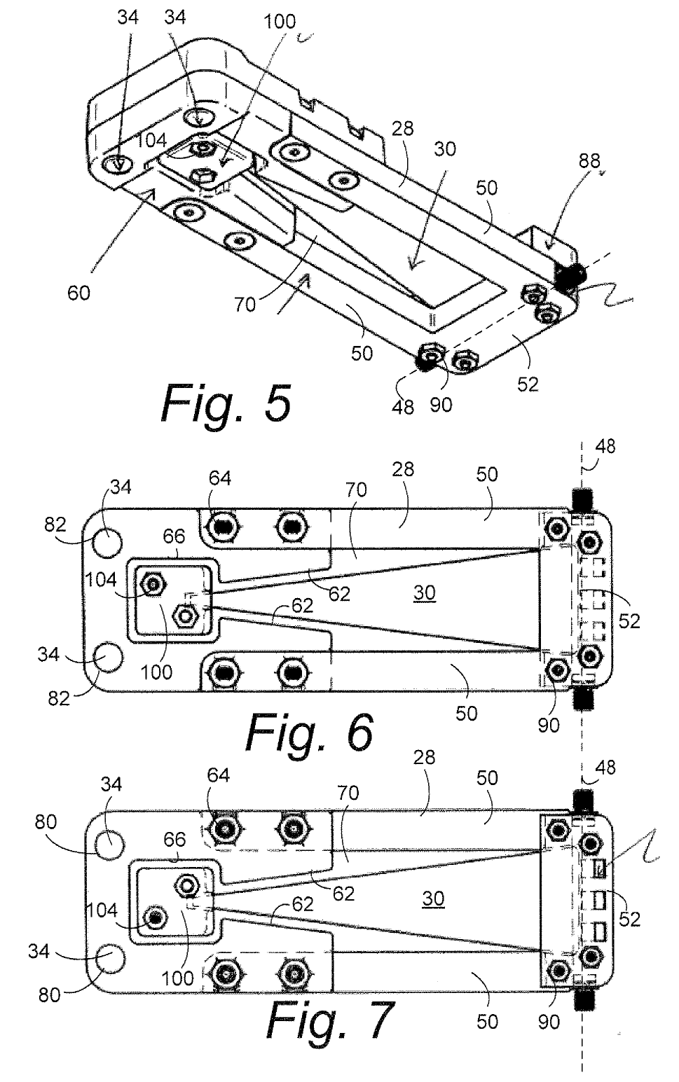

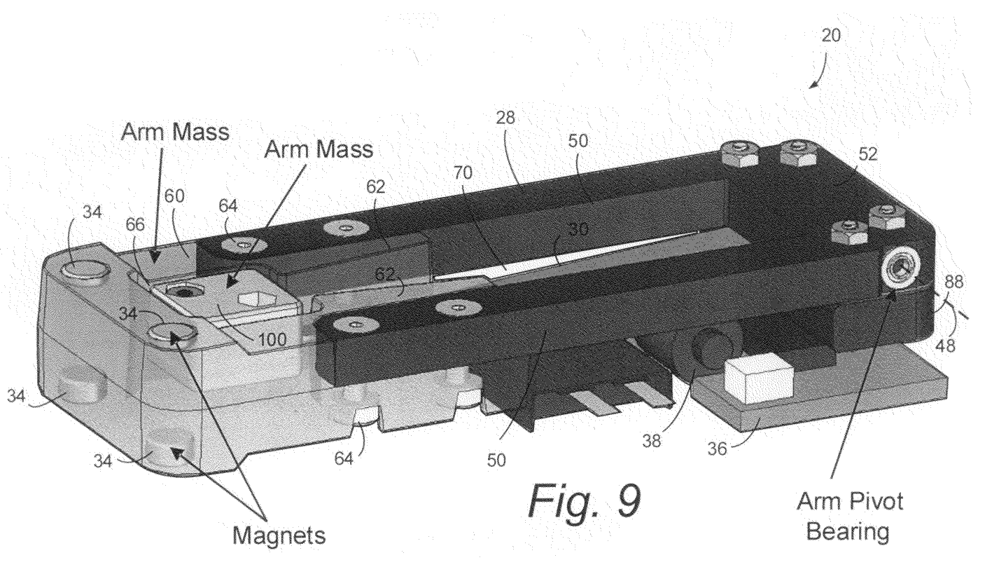

In an example embodiment, body 28 is a cantilevered arm assembly. The cantilevered arm assembly is shown separately (e.g., substantially without frame 22) in each of FIG. 5, FIG. 6, FIG. 7, FIG. 8, and (in sectioned, isometric fashion) FIG. 9. The cantilevered arm assembly is configured to oscillate about pivot axis 48 provided on frame 22. In the illustrated example embodiment, the cantilevered arm assembly comprises two spaced apart, parallel, cantilevered arms 50 which are connected by shoulder 52 proximate pivot axis 48.

The two cantilevered arms 50 which comprise body 28 have body mass 60 bridging and attached to distal ends thereof. The body mass 60 is also known as the “arm mass”. The body mass 60 is configured to comprise two spaced apart body mass segments 62 (see, e.g., FIG. 2) which serve for extensions of and attachment to the respective arms 50. The body mass segments 62 have notches into which the respective arms 50 fit, so that the body mass segments 62 extend interior to an interior side of its respective arm 50 and beneath a bottom surface of its respective arm 50. Fasteners 64 extend through an arm 50 and the respective body mass segment 62 extending therebelow to secure body mass 60 to the two arms 50. The body mass segments 62 have interior-facing surfaces which taper toward one another to a point proximate the full length of the arms 50. A remainder of the body mass 60 from which the body mass segments 62 extend has a distal end and a mass central cavity 66.

The distal end of body mass 60 has a body mass top surface and a body mass bottom surface. The body mass bottom surface is oriented toward the first bumper surface 44; the body mass top surface is oriented toward the second bumper surface 46. The body mass bottom surface has a pair of spaced apart recesses 80 formed therein; the body mass top surface has a pair of spaced apart recesses 82 formed therein. A body magnet 34 is situated in each of the two recesses 80 formed on the body mass bottom surface of the distal end of body mass 60; a body magnet 34 is situated in each of the two recesses 82 formed on the body mass top surface of the distal end of body mass 60. The body magnets 34 are situated in the respective recesses so that the body magnets 34 are indeed recessed below the respective body mass surfaces and therefore do not protrude beyond the body mass surfaces. Thus, the body mass top surface carries two body magnets 34, each of which is recessed and vertically aligned with a corresponding frame magnet 32 positioned in second bumper 42, and likewise the body mass bottom surface carries two body magnets 34 which are recessed and vertically aligned with a corresponding frame magnet 32 positioned in first bumper 40. The recessing or imbedding of the frame magnets 32 in first bumper 40 and second bumper 42 and of the body magnets 34 in the respective surfaces of body mass 60 precludes the frame magnets 32 and body magnets 34 from striking one another, although typically the energy harvesting device 20 is operated so that even the contact of body mass 60 with first bumper 40 and second bumper 42 is unlikely in view of the forces at play, including the magnet forces. Bumpers 40 and 42 are safety stops; during normal operation body mass 60 does not strike bumpers 40 and 42.

Thus, the body magnets 34 aligned with the first bumper frame magnets 32 are situated on the bottom surface at a distal end of body mass 60 of arm assembly 50 and are recessed in recesses 80; the body magnets 32 aligned with the second bumper frame magnets 34 are situated on the upper surface at a distal end of body mass 60 of arm assembly 50 and are recessed in recesses 82. The magnets in each pair (e.g., frame magnet 32 paired with a body magnet 34) are of opposite polarity. This does not necessarily mean that all frame magnets 32 are of a first polarity and all body magnets 34 are of a second polarity, although this is a viable design choice. The magnets pairs are oriented so that they repel one another. There are many different magnet orientations that could be used to create desirable magnet forces.

As understood from the foregoing, body 28 carries at least one body magnet 34 aligned with the first bumper frame magnet 32 and at least one body magnet 34 aligned with the second bumper frame magnet 32. In fact, in the illustrated example embodiment, there are four body magnets 34, each body magnet 34 being vertically aligned with a corresponding one of the frame magnets 32.

The frame magnets 32 and body magnets 34 are preferably strong magnets, such as Neodymium magnets, as a non-exclusive example. The frame magnets 32 and body magnets 34 can be secured in their respective cavities by an adhesive or epoxy, for example. The highly non-linear force verses distance behavior of the magnets allows for sharp impulsive excitations to be created without noise.

In the example illustrated embodiment, the cantilevered arm assembly comprises two spaced apart arms 50 which define an elongated space or cavity 70 therebetween. The piezoelectric element 30 is situated so that piezoelectric element 30 predominately resides in and undergoes deflection in the cavity 70. Example implementations of piezoelectric element 30 are described in United States Patent Publication US 2008-0246367 A1, entitled “TUNED LAMINATED PIEZOELECTRIC ELEMENTS AND METHODS OF TUNING SAME”, and incorporated by reference herein in its entirety. FIG. 10 shows such example piezoelectric element 30 as being an essentially flat, spring-like, cantilevered piezoelectric member which comprises an essentially rectangular attachment shoulder portion 30-1, an elongated triangular mid portion 30-2, and a quadrilateral (e.g., square) distal portion 30-3. The piezoelectric element 30 can be formed as a piezoelectric wafer laminated to a substrate, with the substrate having a non-uniform surface profile. Such non-uniform surface profile can result from plural holes or slots (of same or differing sizes) being provided through the entire thickness of the substrate, as explained in the aforementioned and incorporated application. The piezoelectric element 30 is preferably configured to provide a uniform stress state in the piezoelectric wafer comprising piezoelectric element 30, which leads to significantly higher power outputs.

In the example embodiment the piezoelectric member 30 is a cantilevered piezoelectric member. In particular, the attachment shoulder portion 30-1 of piezoelectric element 30 serves as a proximal end which is clamped to the body 28, e.g., to the arm assembly, near pivot axis 48. In particular, the attachment shoulder portion 30-1 of piezoelectric element 30 is clamped between arm assembly 50 and clamp 88. As shown, e.g., in FIG. 8 and FIG. 3, clamp 88 is positioned on an underside surface of attachment shoulder portion 30-1 of piezoelectric element 30. Fasteners 90 serve to secure clamp 88 to body 28, extending through apertures 92 in piezoelectric element 30 (see FIG. 9), and thereby secure the proximal end of piezoelectric element 30 between clamp 88 and body 28. The clamp 88 carries a plurality of electrical interconnects 94 through which electrical voltage signal(s) may be obtained from piezoelectric element 30 and applied to circuit board 36.

The piezoelectric member 30 comprises a mass-enhanced distal end. In particular, the quadrilateral (e.g., square) distal portion 30-3 of piezoelectric element 30 carries a secondary mass 100 (also known as the “RLP mass”). As shown in FIG. 9, distal portion 30-3 of piezoelectric element 30 has through holes 102 through which fasteners 104 extend (see FIG. 6 and FIG. 7) for securing or mounting secondary mass 100 to distal portion 30-3 of piezoelectric element 30.

An operational objective of energy harvesting device 20 is to increase the displacement of piezoelectric element 30 to a level that is greater than could be achieved by subjecting a piezoelectric electric cantilever to the same vibration input. An additional operational objective of the device is to increase the frequency bandwidth over which the device can harvest usable energy. The energy harvesting device 20 is particularly effective when subjected to a broadband, or impulsive input, such as a vehicular vibration, or that of a walking human. Thus energy harvesting device 20 can be considered to be a vibration amplifier as well as a device that enhances the frequency range over which vibration energy can be collected compared to a singularly resonant device. These are accomplished by (1) adding an additional degree-of-freedom to the vibratory system; and (2) subjecting the lowermost oscillator, the pivoting arm (e.g., arm assembly 50), to a highly non-linear impulsive event provided by pairs of opposing magnets (e.g., in each pair a frame magnet 32 opposing a body magnet 34). In energy harvesting device 20, a first degree of freedom is provided by oscillation of body 28 (e.g., the arm assembly) in frame 22 about pivot axis 48; a second degree of freedom is provided by the ability of piezoelectric element 30 (carried by the oscillating body 28) to defect about its proximal point of attachment (e.g., at clamp 88) to body 28. Impulsive input to the vibratory system simultaneously excites all of the modes of vibration.

The energy harvesting device 20 thus has essentially two moving parts. The first moving part is the body 28 or “arm assembly” which has a pivoting arm to which the body mass 60 is attached. This first part with body 28 is essentially a spring-mass system supported by the magnetic springs realized by frame magnet 32 and body magnet 34. The other moving part is the piezoelectric element 30 which is attached to or bears secondary mass 100 and which forms a second spring-mass system. As combined the two moving parts form a second order (two degree of freedom) vibratory system. This configuration allows the energy harvesting device 20 to operate as a vibration amplifier, increases the operational bandwidth in terms of input frequency, and provides an impulsive input to the piezoelectric element when subjected to random or impulsive inputs to energy harvesting device 20. Since power output is proportional to the frequency of the piezoelectric element 30, higher power outputs can be achieved. The body mass 60 and secondary mass 100 are chosen to maximize the power output of energy harvesting device 20 when exposed to a particular type of vibration input (e.g., vehicular vibration input, for example).

The conventional problem with using an impact to create an impulsive input is that an impact event tends to be noisy. Noisy operation is objectionable in many applications. The energy harvesting device 20 resolves the noise issue by replacing hard stops with powerful magnets, e.g., frame magnets 32 and body magnets 34. The highly non-linear force versus distance behavior of the magnets 32, 34 allow for sharp impulsive excitations to be created without noise.

As described above, body 28 (also known as the arm assembly) is free to rotate on pivot bearings about pivot axis 48, e.g., in response to vibration of frame 22. The arm assembly has a mass (e.g., body mass 60) attached to its free end. The arm/mass (e.g., body mass 60) is supported by magnets (e.g., frame magnets 32 and body magnets 34). Thus the arm assembly is free to oscillate about the pivot point 48 in response to a vibration of the housing 22. However, due to the highly nonlinear force behavior of the magnets 32, 34, the beam undergoes a “soft impact” as the repelling magnets 32, 34 are forced toward one another. This creates an impulsive input to the piezoelectric element 30 which is attached to the arm assembly near pivot 48. This impulsive input excites the piezoelectric element 30 at its resonant frequency. The net effect is that a random input or impulsive input, such as that provided by a vehicle or a walking human, excites the piezoelectric element 30 at its resonant frequency, thus maximizing the power output. The magnets 32, 34, are ideal springs to use in a device of this type as they provide a “quiet impact” and do not absorb energy during the “impact.”

The technology disclosed herein thus pertains to harvesting or scavenging of power by capitalizing upon movement or oscillation of a device, such as a human-carried or human-borne device, for example. The technology disclosed herein can harvest energy from essentially anything that vibrates, but it is particularly effective when subjected to a random-like or impulsive input. The disclosed energy harvesting device could be used to scavenge energy from a walking human or to harvest vehicular vibration energy.

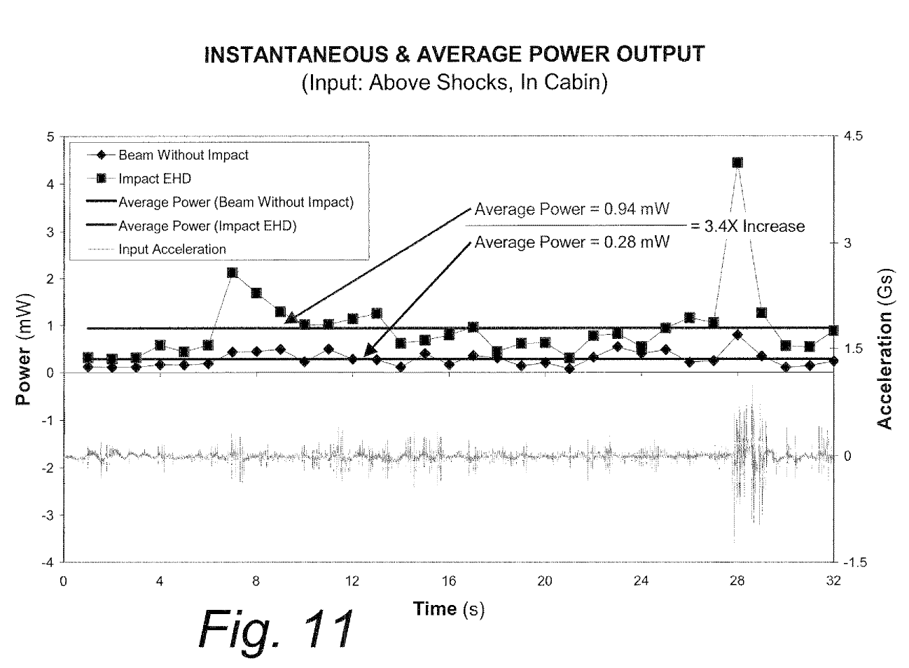

A design criteria for example embodiments is to provide the maximum power output from a piezogenerator given a broadband vibration input such as a vehicular vibration input. Preliminary work showed that the power output from a resonant beam was far lower than what could be achieved with an impact device, as seen in FIG. 11. FIG. 11 shows that power output of the energy harvesting device 20 is 3.4 times greater than an identical energy harvesting beam installed in an impact device and subjected to an identical input. Thus the energy harvesting device 20 provides a significant increase in power output over a resonant device when subjected to an identical input. An additional benefit of the subject device is to improve the frequency bandwidth over which vibration energy can be harvested. This is particularly useful when the vibrational input to the device is of a random nature that includes many different frequencies simultaneously.

One type of laminated piezoelectric element is known as a ruggedized laminated piezoelectric or RLP®, which has a piezoelectric wafer which is laminated to a stainless steel substrate and preferably also has an aluminum cover laminated thereover. Examples of such RLP® elements, and in some instances pumps employing the same, are illustrated and described in one or more of the following: PCT Patent Application PCT/US01/28947, filed 14 Sep. 2001; U.S. Pat. No. 7,191,503 entitled “Piezoelectric Actuator and Pump Using Same”; U.S. Pat. No. 7,198,250 entitled “Piezoelectric Actuator and Pump Using Same”, and United States Patent Publication US 2006-0232171 A1 and U.S. patent application Ser. No. 11/279,647 filed Apr. 13, 2006, entitled “PIEZOELECTRIC DIAPHRAGM ASSEMBLY WITH CONDUCTORS ON FLEXIBLE FILM”, all of which are incorporated herein by reference.

The bonding or lamination of a piezoelectric element such as a piezoelectric ceramic wafer to a substrate or other metallic layer can be performed using a hot melt adhesive. Bonding or lamination using a hot melt adhesive (including a polyimide adhesive such as that known as LaRC-SI™) is taught by one or more of the following U.S. patent documents (all of which are incorporated herein by reference): US Patent Publication US 2004/0117960 A1 to Kelley; U.S. Pat. No. 6,512,323 to Forck et al.; U.S. Pat. No. 5,849,125 to Clark; U.S. Pat. No. 6,030,480 to Face; U.S. Pat. No. 6,156,145 to Clark; U.S. Pat. No. 6,257,293 to Face; U.S. Pat. No. 5,632,841 to Hellbaum; U.S. Pat. No. 6,734,603 to Hellbaum. Other adhesive formulations or bonding/lamination techniques are taught by one or more of the following (all of which are incorporated herein by reference): U.S. Provisional Patent Application 60/877,630, entitled “HOT MELT THERMOSETTING POLYIMIDE ADHESIVES CONTAINING DIACETYLENE GROUPS”; U.S. Provisional Patent Application 60/882,677, entitled “POLYIMIDE/COPOLYIMIDE FILMS WITH LOW GLASS TRANSITION TEMPERATURE FOR USE AS HOT MELT ADHESIVES”; and PCT Patent Application PCT/US07/89006, filed Dec. 28, 2007, entitled “POLYIMIDE/COPOLYIMIDE FILMS WITH LOW GLASS TRANSITION TEMPERATURE FOR USE AS HOT MELT ADHESIVES”.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An energy harvesting device comprising:
a frame;
a piezoelectric member connected to the frame so as to experience two degrees of vibration freedom and upon experiencing vibration to generate an electrical voltage;
a magnetic spring attached to the frame and configured to provide magnetic soft impact of the piezoelectric member relative to the frame.

2. The apparatus of claim 1, further comprising a body, the body being connected to the frame and configured to oscillate with respect to the frame upon vibration of the frame and thereby provide a first degree of vibration freedom, wherein the piezoelectric member is connected to the frame through the body, and wherein the magnetic spring provides magnetic soft impact relative to the frame of the piezoelectric member as connected to the body.

3. The apparatus of claim 2, wherein the body is a cantilevered arm assembly which is configured to oscillate about a pivot axis on the frame.

4. The apparatus of claim 2, wherein the cantilevered arm assembly comprises two spaced apart arms which define a cavity therebetween, and wherein the piezoelectric member is situated to undergo deflection in the cavity.

5. The apparatus of claim 4, wherein the piezoelectric member is a cantilevered piezoelectric member which is clamped to the arm assembly proximate the pivot axis.

6. The apparatus of claim 2, wherein the cantilevered arm assembly comprises an arm mass at a distal end of the arm assembly, and wherein at least a portion of the magnetic spring is mounted to the arm mass.

7. The apparatus of claim 2, wherein the piezoelectric member comprises a mass-enhanced distal end.

8. The apparatus of claim 2, further comprising:
a first bumper and a second bumper provided at spaced apart locations on the frame;
a first bumper frame magnet mounted to the first bumper;
a second bumper frame magnet mounted to the second bumper;
a body magnet aligned with the first bumper frame magnet;
a body magnet aligned with the second bumper frame magnet

9. The apparatus of claim 8, wherein the body magnet aligned with the first bumper frame magnet is situated on a first surface at a distal end of the arm assembly and wherein the body magnet aligned with second bumper frame magnet is situated on a second surface at a distal end of the arm assembly.

10. The apparatus of claim 9, wherein the first bumper has a first bumper surface;
wherein the second bumper has a second bumper surface;
wherein the body has a body first surface oriented toward the first bumper surface;
wherein the body has a body second surface oriented toward the second bumper surface;
wherein the first bumper frame magnet is recessed with respect to the first bumper surface; and
wherein the second bumper frame magnet is recessed with respect to the second bumper surface.

11. An energy harvesting device comprising:
a frame;
a body configured to oscillate with respect to the fame upon vibration of the frame;
a piezoelectric member connected to the body and configured to undergo deflection upon oscillation of the body, and upon the deflection to generate an electrical voltage;
at least one frame magnet mounted on the frame and at least one body magnet mounted on the body, the frame magnet and the body magnet being of opposite polarity with one another and positioned to create a repulsive force between the frame and the body.

12. The apparatus of claim 11, further comprising:
a first bumper and a second bumper provided at spaced apart locations on the frame;
a first bumper frame magnet mounted to the first bumper;
a second bumper frame magnet mounted to the second bumper;
a body magnet aligned with the first bumper frame magnet;
a body magnet aligned with the second bumper frame magnet.

13. The apparatus of claim 12, wherein the body magnet aligned with the first bumper frame magnet is situated on a first surface at a distal end of the arm assembly and wherein the body magnet aligned with second bumper frame magnet is situated on a second surface at a distal end of the arm assembly.

14. The apparatus of claim 12, wherein the first bumper has a first bumper surface;
wherein the second bumper has a second bumper surface;
wherein the body has a body first surface oriented toward the first bumper surface;
wherein the body has a body second surface oriented toward the second bumper surface;
wherein the first bumper frame magnet is recessed with respect to the first bumper surface; and
wherein the second bumper frame magnet is recessed with respect to the second bumper surface.

15. The apparatus of claim 12, wherein the body is a cantilevered arm assembly which is configured to oscillate about a pivot axis on the frame.

16. The apparatus of claim 15, wherein the cantilevered arm assembly comprises an arm mass at a distal end of the arm assembly, and wherein the body magnet aligned with the first bumper and the body magnet aligned with the second bumper are mounted on the arm mass.

17. The apparatus of claim 15, wherein the cantilevered arm assembly comprises two spaced apart arms which define a cavity therebetween, and wherein the piezoelectric member is situated to undergo deflection in the cavity.

18. The apparatus of claim 15, wherein the piezoelectric member is a cantilevered piezoelectric member which is clamped to the arm assembly proximate the pivot axis.

19. The apparatus of claim 18, wherein the piezoelectric member comprises a mass-enhanced distal end.
